(19) United States
(12) Patent Application Publication
(10) Pub. No.: US 2015/0058119 A1
(43) Pub. Date: Feb. 26, 2015

(54) Automated Advertisement of Products on Online Sites

(71) Applicant: SocialWire, Inc., San Francisco, CA (US)

(72) Inventors: Selcuk Atli, San Francisco, CA (US); Jose Reyes, Berkeley, CA (US); Bob Buch, Menlo Park, CA (US); Ryo Chijiiwa, Berkeley, CA (US); Stefan Nikolic, San Francisco, CA (US); Andy Horng, San Francisco, CA (US); Allison Carlisle, Alameda, CA (US)

(21) Appl. No.: 14/466,901

(22) Filed: Aug. 22, 2014

Related U.S. Application Data
(60) Provisional application No. 61/868,747, filed on Aug. 22, 2013.

(51) Int. Cl. G06Q 30/02

(52) U.S. Cl. CPC G06Q 30/0276; G06Q 30/0273; G06Q 30/0251
USPC 705/14.49; 705/14.69

(57) ABSTRACT

A promotion engine retrieves information associated with a merchant's inventory for online sites. The promotion engine uses the retrieved information to identify products to promote on an online site. An advertisement campaign is generated for the merchant by the promotion engine to promote the products and the promotion engine also purchases advertising placements associated with the online site. Advertisement content of the advertisement campaign is sent to the online site by the promotion engine and the advertisement campaign is maintained by the promotion engine for the merchant.

### CROSS-REFERENCE TO RELATED APPLICATIONS

This application claims the benefit of U.S. Provisional Application No. 61/868,747, filed on Aug. 22, 2013, which is hereby incorporated by reference in its entirety.

### BACKGROUND

The disclosure generally relates to promoting products offered on a merchant site to users of an online site, in particular to creating automated advertisement campaigns for products offered on the merchant site.

Online sites touch various facets of an online user's experience, including the user's social life (through online sites and tools), current interests (through news and blog sites), and shopping experience (through various online merchant sites). Merchants may promote their products to users online through various tools like displaying advertisement to users on the online sites. However, creating highly targeted advertisement campaigns that include every product is a cumbersome task for merchants who are already swamped with numerous other issues related to their business. Merchants constantly have to make manual decisions around which products they should promote, which users to target and how to target them, how much to bid for every product ad and build and manage creatives for every product around a cohesive marketing strategy. This hinders the capability for merchants to place a high number of targeted product promotions on online sites and results in lost monetization opportunities for online sites, inefficient and ineffective advertising campaigns for merchants and irrelevant advertising for users on online sites.

### SUMMARY

To assist a merchant in promoting their products on an online site, a promotion engine retrieves information about the merchant's inventory stored in an inventory database and identifies products to be promoted (hereinafter “promoted products”). The merchant's inventory database stores attributes for its products, like quantity of available product and geographical location where most of the product is likely to be sold. Thus, the retrieved information includes attributes of the products and the promotion engine identifies promoted products based on these attributes. In another embodiment, the promoted products can be identified based on an analysis of the retrieved information.

Then, the promotion engine purchases advertising placements from the online site for these promoted products. Additionally, the promotion engine generates an advertisement campaign to promote the promoted product on the online site. An advertisement campaign defines a set of ads and information about how the ads are to be served to users, including creatives, bids and targeting criteria for the ads in the campaign. Additionally, a campaign's temporal attribute may indicate a time period during which the advertisements may be shown to users. The purchase of the advertising units and creation of advertisement campaigns results in the online site presenting product advertisements to pertinent users for promoted products. Although the description herein specifies the promotion engine creating advertisement campaigns for an online site, one of ordinary skill in the art will understand that these campaigns can also be used to promote products on any advertisement publishing network such as a social networking site.

### BRIEF DESCRIPTION OF THE DRAWINGS

FIG. 1 is a block diagram of a system environment in which a promotion engine operates, in accordance with an embodiment.

FIG. 2 is a flowchart of a method for automating advertisement of products on an online site, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

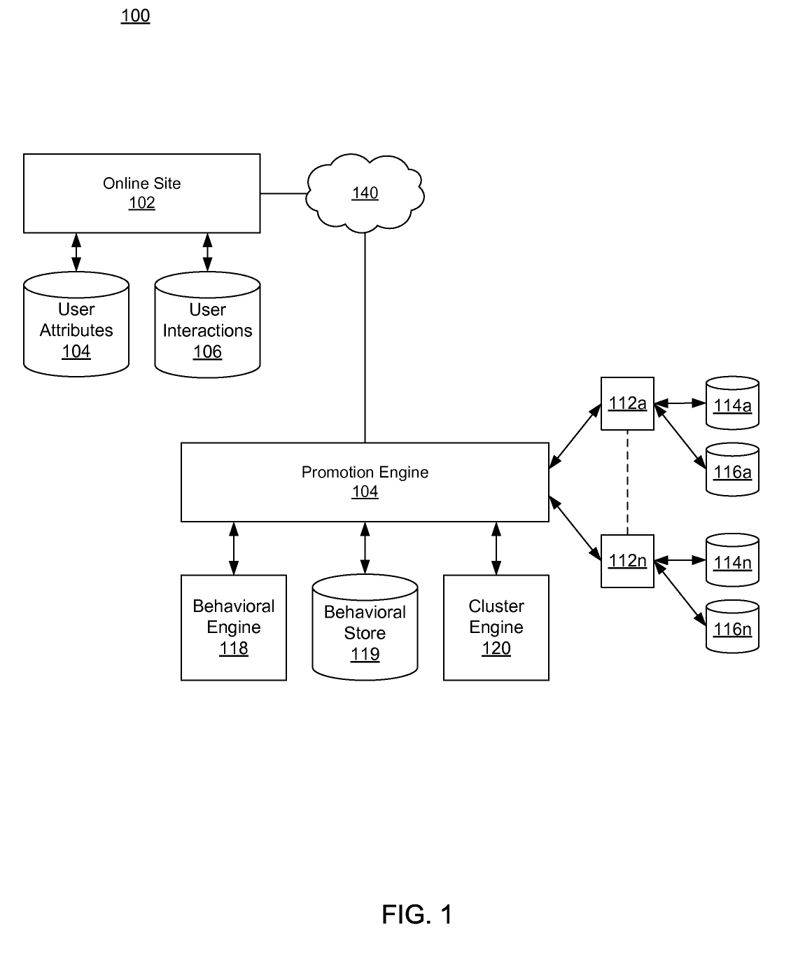

FIG. 1 is a block diagram of a system environment in which a promotion engine operates, in accordance with an embodiment. The system environment includes a system 100 that automatically promotes products by purchasing advertising placements on and generating advertisement campaigns for an online site. The system 100 includes an online site 102, a promotion engine 104, merchant sites 112a-n, and a network 140. Additional online sites and promotion engines may be present in the system 100 and interact with each other in a similar manner as described herein. In various embodiments, the online site 102 and/or the merchant sites 112a-n can be applications executing on a client device.

The online site 102 is communicatively coupled to a user attribute database 104 and a user interaction database 106. These databases 104, 106 store users' social data indicating the user's connections (e.g., friends), interests, preferences, groups, etc. For example, the online site 102 can be a social networking site and the databases can store social graph information and social interaction information. The user attribute database 104 stores a graph (e.g., a social graph) that includes information indicating a user's relationship with other entities in the community, such as users, merchants, merchants' products, and other entities represented by a web page. The user interaction database 106 stores data indicating a user's and the user's connections' interactions with other entities in the online community. For example, the database 106 may store comments from the user regarding a product or information indicating a user's preference for the product (e.g., like, love, favorite, dislike). The online site 102 collects data regarding various users as they interact on the online site 102 and populate the databases 104, 106 with the collected information.

The merchant sites 112a-n are communicatively coupled to their corresponding inventory databases 116a-n and consumption databases 114a-n. Each inventory database 116 for a merchant site 112 may store information about the products or services (hereinafter referred to as “products”) offered on the merchant site 112 and is manually or automatically populated by the merchant site 112 through a user interface or through known data mining techniques. The inventory database 116 includes identifying information for each product that uniquely identifies the product on the merchant site 112. For example, the identifying information for a product can be a stock keeping unit (SKU). Additionally, the inventory database 116 stores attributes for each product like a quantity attribute indicating the amount of product available for sale, a location attribute indicating geographical location where applicable (e.g., A Radiohead concert taking place in Oakland, Calif. should be promoted to users who live nearby or a Yoga deal only available in New York City should be promoted to users who live in New York City), a temporal attribute indicating the date when the product will no longer be in sale or available where applicable (e.g. Sale or promotion for the Calvin Klein T-Shirt ends in 2 days), categories (e.g. under men and t-shirt categories), brands or keyword attributes indicating keywords associated with the product.

The merchant site 112 collects data about each user's interaction with the merchant site 112 as the user browses through the merchant site 112 and interacts with and purchases various products on the merchant site 112. The merchant site 112 stores the collected data about the user as consumption data in the consumption database 114. Examples of stored consumption data include clickstream data indicating a user's interaction with various parts of the merchant site (e.g., viewing, selecting, clicking, or interacting with a particular part of the page displaying a particular product); shopping cart data indicating the user's interaction with a shopping cart (e.g., adding to, removing from, or buying products placed within a shopping cart); purchasing data indicating purchases a user has made; and search data indicating the searches the user has performed on the merchant site 112 and incoming search terms that led a user to the merchant site 112. The stored consumption data can be associated with different labels describing behaviors of users including “Purchase,” “Add to Cart,” “Registration,” and any other suitable description of a user's behavior on a merchant site 112. Additionally, the merchant site 112 receives, from the users or an external source, and stores the users' identity on the online site 102 and demographic information, such as the users' sex, age group, income level, and place of residence.

The promotion engine 104 determines products offered by the merchant site 112 that should be promoted on the online site 102 and purchases advertising placements for promoting the offered products to users on the online site 102. The promotion engine 104 is communicatively coupled to a behavioral engine 118 and a cluster engine 120. In alternative embodiments, the behavioral engine 118, the behavioral store 119, and cluster engine 120 are modules of the promotion engine 104 or the functionality of the behavioral engine 118, the behavioral store 119 and cluster engine 120 are performed by the promotion engine 104 or other suitable modules. The behavioral engine 118 organizes data from the consumption database 114 by product attributes such as identifying information (e.g., a stock keeping unit (SKU) associated with a product). The behavioral engine 118 can store the organized data in a behavioral store 119. The cluster engine 120 generates product clusters for merchants and similar audience clusters for merchants.

The cluster engine 120 generates product clusters by grouping products that are similar to each other. In one embodiment, similarity is determined by extracting attributes including key phrases from the product description of the product, name of the product, price of the product, color of the product, size of the product, and any other suitable attributes of the product. Using the extracted attributes, the cluster engine 120 determines a “distance” between products and the distance can be a value quantifying differences in attributes. For example, distance can be based on price differences between products. If product A is $40 and product B is $20, then product A and product B are twice the distance from each other. Distance can also be based on frequency of attributes (e.g., keywords) between products.

The cluster engine 120 generates audience clusters of “similar audiences” for each merchant site 112 by grouping audiences that are similar to each other. In one embodiment, similarity is determined based on comparisons of attributes of an audience where attributes include gender, age, interests, income level, and any other suitable information associated with the audience maintained by the merchant site 112. Using the attributes, the cluster engine 120 determines a “distance” between the audiences and the distance can be a value quantifying differences in attributes, in a similar manner as described previously for product clusters. For example, two audiences primarily interested in television are more similar to each other than two audiences primarily interested in radio.

The network 140 represents the communication pathways between the online site 102, the promotion engine 104, and the merchant sites 112a-n. In one embodiment, the network 140 is the Internet. The network 140 can also use dedicated or private communication links that are not necessarily part of the Internet.

### Automated Product Advertisement on an Online Site by the Promotion Engine

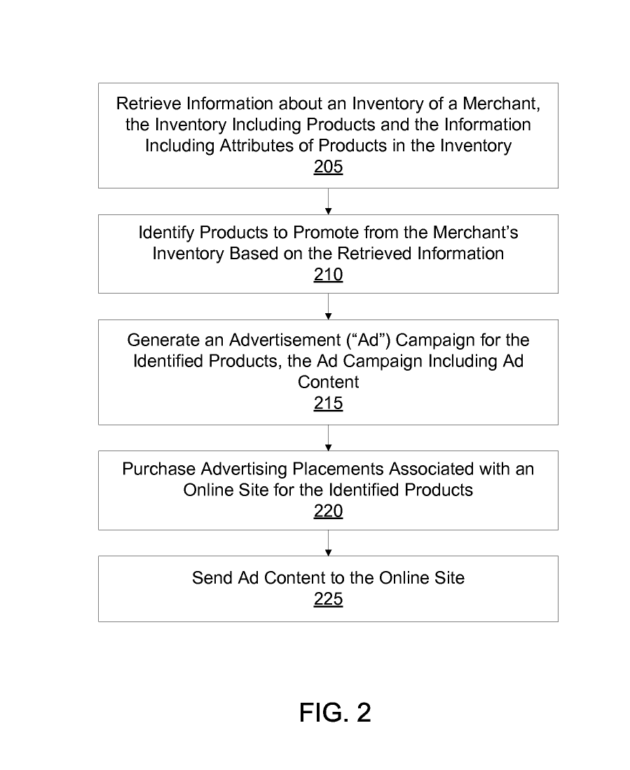

FIG. 2 is a flowchart of one embodiment of a method for automating advertisement of products on an online site 102. In other embodiments, the method may include different and/or additional steps than those shown in FIG. 2. Additionally, steps of the method may be performed in different orders than the order described in conjunction with FIG. 2.

The promotion engine 104 retrieves 205 information about an inventory of the merchant. The inventory includes one or more products associated with the merchant and the information including attributes of one or more products in the merchant's inventory. An attribute of a product can be information that describes the product, describes metadata associated with the product, or any other suitable information maintained by a merchant site or online site of the product. Example attributes include quantity attributes, location attributes, temporal attributes, and any other suitable attribute, further described below.

The promotion engine 104 identifies 210 one or more products to promote from the merchant's inventory based at least in part on the retrieved information. In other embodiments, the promotion engine 104 can access information of performance of the one or more products on various online sites 102. Then, the promotion engine 104 can identify 210 one or more products based at least in part on the performance information. Example performance information of a product on an online site 102 includes a number of interactions with a content item (e.g., advertisement content) associated with the product, a click through rate (CTR) of the product, impression rate of the product, or any other suitable measure of how well content items associated with the product perform on the online site.

The promotion engine 104 generates 215 an advertisement (“ad”) campaign for the identified one or more products. The ad campaign includes advertisement (“ad”) content for at least one of the identified one or more products. Ad content of a product includes various components such as text, image, link, attributes of, and any other suitable information associated with the product that a merchant would advertise on an online site 102, as further described below.

The promotion engine 104 purchases 220 one or more advertising placements associated with an online site for the identified one or more products. For example, the merchant may specify a budget and an amount of advertising placements purchased 220 by the promotion engine 104 can be based on the budget.

The promotion engine 104 sends 225 the advertisement content of the advertisement campaign to the online site 102 to be presented in at least one of the one or more purchased advertisement placements. In addition, the promotion engine 104 can also send targeting criteria and bid criteria to the online site 102 associated with the product of the sent advertisement content. The method described in FIG. 2 is further described below.

Defining Advertising Placements Using Information from Merchant's Database

In one embodiment, the promotion engine 104 automatically determines or identifies 210 one or more products to promote at the online site 102 on behalf of a particular merchant using product selection criteria defined by the merchant. The promotion engine 104 identifies 210 the one or more products to promote in an advertisement campaign by analyzing the products' attributes stored in the inventory database 116 and/or the consumption data stored in the consumption database 114 at the merchant site 112. The promotion engine 104 then promotes the products by purchasing 220 advertising placements at the online site 102.

The promotion engine 104 may identify 210 which products to promote using a variety of rules and filters. For example, the promotion engine 104 identifies 210 for promotion: products whose quantity attribute indicates that at least a threshold amount of product is available for sale; products whose keywords match to specified keywords (e.g. promote deals that match the keyword ‘yoga’); and products who are on discount or in a certain price range (e.g. promote products where price is between $50 and $300, promote products with at least a 25% discount, promote products less than $50).

The promotion engine 104 may also identify 210 one or more products to promote by ranking, sorting, or scoring products based on certain criteria. In one embodiment, the promotion engine 104 identifies 210 one or more products to promote by sorting available products by recent consumption trends. For example, the promotion engine 104 can promote bestselling or most liked 100 products in a specified interval of time, a region, associated with an event, or any combination thereof. In another embodiment, the promotion engine 104 identifies 210 one or more products to promote by sorting products based on ascending or descending product attributes. For example, the promotion engine 104 can promote products based on price, promote products with the largest discount, promote products based on discount, or promote products with the most availability. In yet another embodiment, the promotion engine 104 identifies 210 one or more products to promote by sorting products based on distances. For example, the products are ranked or selected based on an average threshold difference in distance from at least a threshold number of products. Then, a threshold number of products in the ranking or products with at least a threshold position in the ranking are identified 210.

In addition, the promotion engine 104 may also identify 210 one or more products from the merchant catalog to promote by crawling the products presented on a promotional page on the merchant site 112 or retrieve 205 products related to the promotion or information of products related to the promotion from the inventory database 116 and/or the consumption data stored in the consumption database 114 at the merchant site 112. For example, the promotion engine 104 can automatically promote a collection of products associated with an event by including each product in an advertising campaign and submitting them to the online site 102 for placement. Example events include back to school season, sports events, mother's day, any other suitable holiday, or anniversary.

After identifying products to be promoted, the promotion engine 104 purchases 220 advertising placements for the promoted products from the online site 102. When purchasing 220 an ad placement for a product, the promotion engine 104 may communicate or send 225 bidding criteria, one or more creatives and a set of targeting criteria to the online site 102.

After purchasing 220 the advertising placements for the promoted products, the promotion engine 104 frequently updates the advertising campaign with new products that are eligible for promotion according to the selection criteria (e.g. a new product on sale is automatically included in the campaign) and removes products that no longer satisfy the promotion criteria from the campaign (e.g. a product goes out of stock is automatically removed from the campaign). The promotion engine 104 can update the advertising campaign in specified intervals of time, daily, weekly, responsive to events indicating adding or removing products (e.g., product goes on sale, goes out of stock, etc.), or based on any other suitable timeline.

### Advertisement Content (Ad Creative) Generation

In one embodiment, the promotion engine 104 automatically generates 215 an advertisement campaign and advertisement content included in the advertisement campaign. The promotion engine 104 automatically determines or generates 215 an ad content (e.g., ad creative) for the merchant's products, thereby saving the merchant time creating an ad for each product. To generate 215 an ad creative for a particular product, the promotion engine 104 analyzes the product information for the promoted product retrieved from the merchant site 112 (e.g., databases 114, 116, 119) and combines this with one or more advertising templates defined by the merchant to determine advertisement content. For example, the product information may indicate a promotional price (e.g., a discounted price), a discount or offer associated with the product, an image of the product, and/or a set of features of the product. These product features can vary for various merchant sites 112 depending on the type of merchant site 112. Example features however include color and brand for a furniture merchant, artist and venue for a concert ticketing site, and any other suitable information of a product. The promotion engine 104 analyzes and retrieves the product information and uses the advertising template to generate the advertisement content based on the retrieved product information, and transmits the advertisement content to the online site 102.

In one embodiment, the promotion engine 104 dynamically determines or generates 215 advertisement content for each product based on an advertising template defined by the merchant. The advertising template may have promotional content with static language and place holders for dynamic content such as title, category, price, discount, an end date of a sale, a number of products left in stock, or any other product attribute that may be available. For example, the advertisement template may be, “{discount}—Don't miss our sale from {brand} for only {price} ! Only {stock} left.” In this example, the promotion engine 104 can use this advertising template to determine the advertising content as follows: “30% off—Don't miss our sale from Calvin Klein for $200! Only 3 left.” The promotion engine 104 may also determine if an image is associated with the promoted product and include the associated image in the advertisement content transmitted to the online site 102 for each promoted product. The promotion engine 104 may also use the product attributes to include visual overlays on the associated product image of the advertisement content such as the product's price, discount or availability.

In one embodiment, the promotion engine 104 generates 215 one or more advertisement content for a promoted product and selects one or more advertisement content from the generated 215 one or more advertisement content based on user feedback. The one or more advertisement content for each product can be generated 215 by using one or more advertisement templates in the advertisement campaign. The generated 215 advertisement content is presented to users and the users indicate the presented content that was most effective in the users' opinions. Based on this feedback, the promotion engine 104 selects a threshold number of advertisement content for promoting the product. The feedback may be explicit (e.g., user's rate the ads) or implicit (e.g., based on observed CTR or impressions for the ads).

### Defining Targeting Criteria Based on Merchant Catalog Information

The promotion engine 104 determines one or more targeting criteria for identifying users on the online site 102 to whom the advertising placements or ads in the advertisement campaign are presented. In one embodiment, static targeting criteria are associated with the advertisement campaign generated by the promotion engine 104. The static targeting criteria can include demographics, location, interests, or any other targeting options made available by the online site 102. This targeting feature in combination with the product selection criteria defined in the advertisement campaign enables the promotion engine 104 to automatically promote different subsets of products in the catalog of the merchant site 112 to different target audiences specified by the merchant. For example, using this mechanism the promotion engine 104 can automatically promote most popular and available male t-shirts to males while it can promote the most popular and available female t-shirts to females.

In another embodiment, the promotion engine 104 can dynamically include different location targeting criteria for each product advertisement based on attributes of the products in the inventory database 116 at the merchant site 112. In some cases, merchant sites 112 can only promote products that are locally available to their exact or surrounding locations. For example, a concert in San Francisco, Calif. can only be promoted to users of the online site 102 who reside in San Francisco or a Yoga deal locally available in New York City can only be promoted to users of the online site 102 who live in New York. To accomplish this, the promotion engine 104 turns a product attribute (where available) such as city or zip code into location targeting criteria and a targeting radius then assigns this targeting criteria to each advertisement associated with the product and submits them to the online site 102 for placement.

In another embodiment, the promotion engine 104 can dynamically include interest and keyword targeting criteria for each product advertisement based on attributes for the products in the inventory database 116 at the merchant site 112 or keywords that can be retrieved from these product attributes using known data mining techniques. For example, the promotion engine 104 can promote a yoga deal to users on the online site 102 who are interested in yoga and similar keywords or the promotion engine 104 can promote concert by the band Radiohead to users of the online site 102 who are interested in Radiohead or similar bands. The promotion engine 104 can perform this automatically for each promoted product and submit this to the online site 102 as interest or keyword targeting criteria.

### Self-Learning Keyword Dictionary for Targeting of Product Advertisements

In another embodiment, the promotion engine 104 stores targeting keywords assigned to each advertisement and records user feedback and success of each advertisement such as clicks, social engagement (likes and comments), and other merchant goals (e.g., purchases and sign ups). The promotion engine 104, then re-assigns historically successful keywords to the advertisement of other similar products, for example, that are similar based on distances. The promotion engine 104 can apply known data mining and machine learning techniques to calculate product similarity by using product attributes such as price, category or consumption patterns such as page views and purchases. For example, if the keywords “cute” and “punk” have performed successfully for a clothing product on a previous advertisement, the promotion engine 104 can assign these two keywords to another new advertisement that is from the same category, in a similar price range, in the same price range, or any combination thereof.

### Dynamic Targeting of Advertisements Based on User Profiles of Customers

The merchant site 112 collects data about each user's interaction with the merchant site 112 such as page views and purchases. In addition, the merchant site 112 collects and stores user profile data of these customers from the online site 102 such as demographic information that includes users' sex, age group, income level, and place of residence, interests and activities they shared on the online site 102. For example, the data collected by the merchant site 112 is any suitable data stored in the databases 104 and 106 The merchant site 112 transmits this information to the promotion engine 104 that then correlates the consumption patterns and the user profile data of the customers.

In one embodiment, the promotion engine 104 analyzes consumption data 114 and the user profile data (e.g., user attribute data 104 and user interaction data 106) of the customers to identify common demographics, interests and shared activities of customers who have performed certain actions (e.g. page views or purchases) against a subset of the product catalog. These common characteristics can be mined by the promotion engine 104 using known data mining techniques, such as clustering. These common characteristics can be assigned by the promotion engine 104 to the product advertisements as targeting criteria in order to find new audiences on the online site 102. For example, the promotion engine 104 can analyze the consumption and user profile data of customers who have previously bought male t-shirts over $60 and promote new and popular male t-shirts in the same price range to a similar new audience on the online site 102. This enables the merchant site 112 to find new audiences on the online site 102 who are similar to the already existing customers of its products, for example, through the cluster engine 120.

### Dynamic Remarketing of Advertisements Based on Past Customer Behavior

In one embodiment, the promotion engine 104 dynamically determines one or more existing customers of the merchant site to target products in an advertisement campaign on the online site 102. The promotion engine 104 transmits personally identifiable user information that belongs to these customers to the online site 102. The personally identifiable user information was previously stored in the merchant's consumption database 114. The online site 102 can cross-reference the personally identifiable user information with its user attribute database 104 to effectively promote the products in the campaign to those users. The personally identifiable user information may be encoded or hashed by the promotion engine 104 for privacy concerns. This targeting technique helps the merchant site 112 promote their products in highly targeted ways to their existing customers in the online site 102.

The promotion engine 104 can dynamically determine one or more users to target the products in the advertisement campaign by analyzing the consumption data in the merchant's consumption database 114 and the inventory database 116. Any variety of data analysis techniques may be used, such as machine learning techniques, regression analysis and collaborative filtering. The promotion engine 104 analyzes the products that are being promoted and finds a customer that may be interested in purchasing these products. For example, the analysis may indicate that a yoga deal will be promoted to a group of customers who have previously purchased a deal in the same category and price range more than once. In another example, using a collaborative filtering technique, the analysis of the promotion engine 104 may also identify correlations or relationships between or among brands. For example, the analysis may indicate that people who buy male t-shirts over $60 also buy jeans from a certain brand. Therefore, the promotion engine 104 would promote popular male t-shirts over $60 to customers who purchased jeans from this brand on the online site 102. The promotion engine 104 also frequently updates the targeting criteria of the advertising campaigns with recent consumption data from the merchant site 112. For example, the update can be every specified interval of time, daily, weekly, or responsive to an event (e.g., adding or removing a product from an advertising campaign).

### Dynamic Prospecting of Advertisements Based on Past Customer Behavior

In one embodiment, the promotion engine 104 dynamically determines one or more customers of the merchant site 112 who previously have interacted with (e.g. purchased, bookmarked, favorited, etc.) with the products being promoted in the advertisement campaign and with similar products. Similar products can be determined by the promotion engine 104 by using product attributes or consumption patterns and known machine learning techniques such as collaborative filtering. The promotion engine 104 then submits or sends identifying information of the one or more customers to the online site 102 in order to promote the products in the advertisement campaign to other users of the online site 102 that are most similar to the user in the transmitted segment. The online site 102 may use a number of known machine learning techniques to find similarity among its users. The promotion engine 104 may encode the personally identifiable information in the submitted user segments for privacy reasons. This technique enables the merchant to target new audiences on the online site 102 that are similar to its customers. For example, when promoting a yoga deal over $50, the promotion engine 104 may dynamically submit a customer segment of users who have previously purchased deals from the same category and in the same price range more than once. Then, the online site 102 would promote this yoga deal other users who are similar.

### Dynamic Bidding Based on Product Attributes and User Feedback

The merchant may want to bid less than the net margin of each product when advertising them on the online site 102 to achieve a positive return on investment on the advertisement campaign. In one embodiment, the promotion engine 104 can calculate different bids for each promoted product based on their unique price and margin, assign each bidding criterion to the corresponding advertisements, and transmit them to the online site 102. For example, the promotion engine 104 would assign $20 against the purchase of a product that is priced at $100 and that has a net margin of 20%. This way, the promotion engine 104 can manage different bidding criteria in a single campaign for multiple advertisements.

Since there will be numerous advertisements in an advertisement campaign built by the promotion engine 104, it is expected that some advertisements will perform better than other advertisements on the online site 102 where success can be determined by the number of clicks, social engagement (likes and comments), interactions, and merchant goals such as purchases and sign ups. In one embodiment, the promotion engine 104 can continuously retrieve performance of each product advertisement from the online site 102 and dynamically shift the amount of advertising budget spent to the best performing advertisements and stop spending on advertisements that have consistently been performing poorly against the given targeting criteria and advertising creatives. This enables the promotion engine 104 to help maximize the return on advertising spend for product advertising placed on the online site 102 for the merchant site 112.

### Summary

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the user interface arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
retrieving information about an inventory of a merchant, the inventory including one or more products associated with the merchant, and the information including attributes of one or more products in the merchant's inventory;
identifying one or more products to promote from the merchant's inventory based at least in part on the retrieved information;
generating an advertisement campaign for the identified one or more products, the advertisement campaign including advertisement content for at least one of the identified one or more products;
purchasing one or more advertising placements associated with an online site for the identified one or more products; and
sending the advertisement content of the advertisement campaign to the online site to be presented in at least one of the one or more purchased advertisement placements.

2. The method of claim 1, wherein attributes can be selected from a group consisting of: quantity attribute, temporal attribute, location attribute, and any combination thereof.

3. The method of claim 2, wherein a quantity attribute information associated with pricing of or quantity in stock of the product

4. The method of claim 2, wherein a temporal attribute is selected from a group consisting of: information associated with an interval of time associated with a pricing of the product, an occasion, an event, and any combination thereof.

5. The method of claim 2, wherein a location attribute is any information associated with geographic location of the product.

6. The method of claim 1, wherein identifying one or more products to promote from the one or more products in the merchant's inventory based at least in part on the retrieved information further comprises:
receiving product selection criteria from the merchant, the product selection criteria specifying a filter selected from a group consisting of: an attribute, a threshold number of attributes, a bid amount, product information, product features, and any combination thereof.

7. The method of claim 1, wherein the advertisement content included in the advertisement campaign is included based on an advertising template defined by the merchant.

8. The method of claim 7, wherein the advertising template includes static language and place holders for dynamic content, the dynamic content selected from a group consisting of: title, category, price, discount, end date of a sale, a number of products left in stock, and any combination thereof.

9. The method of claim 1, further comprising:
determining one or more targeting criteria based on static targeting criteria associated with the advertisement campaign, the static targeting criteria selected from a group consisting of: demographic information of a user, location associated with a user, interests of a user, and any combination thereof.

10. The method of claim 9, wherein the static targeting criteria is specified by the merchant.

11. The method of claim 10, wherein an advertisement content of the advertisement campaign includes keywords, further comprising:
associating the advertisement content with the included keywords if the advertisement content receives a threshold number of interactions by users of the online site.

12. The method of claim 1, further comprising:
receiving an indication that an advertisement content in the advertisement campaign received a threshold number of interactions by users of the online site; and
adjusting a budget associated with the advertisement campaign to present the advertisement campaign more often.

13. The method of claim 1, further comprising:
removing an identified product from the advertisement campaign if the identified product is out of stock.

14. A computer program product comprising a computer readable storage medium containing computer program code for:
retrieving information of a merchant's inventory, the inventory including one or more products associated with the merchant and the information including attributes of one or more products in the merchant's inventory;
identifying one or more products to promote from the merchant's inventory based at least in part on the retrieved information;
generating an advertisement campaign for the identified one or more products, the advertisement campaign including advertisement content for at least one of the identified one or more products;
purchasing one or more advertising placements associated with an online site for the identified one or more products; and
sending the advertisement content of the advertisement campaign to the online site to be presented in at least one of the one or more purchased advertisement placements.

15. The computer program product of claim 14, wherein identifying one or more products to promote from the one or more products in the merchant's inventory based at least in part on the retrieved information further comprises:
receiving product selection criteria from the merchant, the product selection criteria specifying a filter selected from a group consisting of: an attribute, a threshold number of attributes, a bid amount, product information, product features, and any combination thereof.

16. The computer program product of claim 14, wherein the advertisement content included in the advertisement campaign is included based on an advertising template defined by the merchant, the advertising template including static language and place holders for dynamic content, the dynamic content selected from a group consisting of: title, category, price, discount, end date of a sale, a number of products left in stock, and any combination thereof.

17. The computer program product of claim 14, further comprising:
determining one or more targeting criteria based on static targeting criteria associated with the advertisement campaign, the static targeting criteria selected from a group consisting of: demographic information of a user, location associated with a user, interests of a user, and any combination thereof.

18. The computer program product of claim 17, wherein an advertisement content of the advertisement campaign includes keywords, further comprising:
associating the advertisement content with the included keywords if the advertisement content receives a threshold number of interactions by users of the online site.

19. The computer program product of claim 1, further comprising:
receiving an indication that an advertisement content in the advertisement campaign received a threshold number of interactions by users of the online site; and
adjusting a budget associated with the advertisement campaign to present the advertisement campaign more often.

20. The computer program product of claim 1, further comprising:
removing an identified product from the advertisement campaign if the identified product is out of stock.
